(19) United States
(12) Patent Application Publication
(10) Pub. No.: US 2023/0402634 A1
(43) Pub. Date: Dec. 14, 2023

(54) DYNAMIC CONTROL OF PARALLEL CONNECTED FUEL CELL SYSTEMS

(71) Applicant: HYDROGENICS CORPORATION, Mississauga (CA)

(72) Inventors: Nader ZAAG, Milton (CA); Sonia SORBERA, Woodbridge (CA); Nathaniel Ian JOOS, Toronto (CA); John Yui Ki POON, Thornhill (CA)

(21) Appl. No.: 18/319,078

(22) Filed: May 17, 2023

Related U.S. Application Data
(60) Provisional application No. 63/351,094, filed on Jun. 10, 2022.

(51) Int. Cl. H01M 8/04992; H01M 8/249; H01M 8/2457; H01M 8/2475

(52) U.S. Cl. CPC H01M 8/04992; H01M 8/249; H01M 8/2457; H01M 8/2475; H01M 2250/20

(57) ABSTRACT

The present disclosure generally relates to systems and methods for operating a fuel cell system including at least two or more fuel cell systems that are connected in a parallel configuration.

### CROSS-REFERENCE TO RELATED APPLICATIONS

This nonprovisional application claims the benefit and priority, under 35 U.S.C. § 119(e) and any other applicable laws or statues, to U.S. Provisional Patent Application Ser. No. 63/351,094 filed on Jun. 10, 2022, the entire disclosure of which is hereby expressly incorporated herein by reference.

### TECHNICAL FIELD

The present disclosure generally relates to systems and methods for powering a load by utilizing at least two or more fuel cell systems that are connected in a parallel configuration.

### BACKGROUND

Vehicles and/or powertrains use fuel cells or fuel cell stacks for their power needs. A fuel cell and fuel cell stack may include, but are not limited to a phosphoric acid fuel cell (PAFC), a molten carbonate fuel cell (MCFC), a proton exchange membrane fuel cell, also called a polymer exchange membrane fuel cell (PEMFC), or a solid oxide fuel cell (SOFC).

A fuel cell or fuel cell stack may generate electricity in the form of direct current (DC) from electro-chemical reactions that take place in the fuel cell or fuel cell stack to power various applications.

Optimal use of a plurality of fuel cell systems comprising one or more fuel cell stacks increases efficiency and the power available to various applications. The plurality of the fuel cell systems may be configured in a series, a parallel, or a mixed configuration when powering the various applications. The present disclosure provides systems and methods for optimizing the operation of a plurality of fuel cell systems in a parallel configuration. The present disclosure provides systems and methods to determine when to initiate the operation of each of the plurality of fuel cell systems in a parallel configuration depending on a load power (P_{load}) required by the various applications.

### SUMMARY

Embodiments of the present disclosure are included to meet these and other needs.

In one aspect, described herein, a parallel configured system comprises a plurality of fuel cell systems, a switching device, an energy conversion device, a load, and a control unit. The plurality of fuel cell systems are electrically connected in a parallel configuration. The switching device is connected in series to each of the plurality of the fuel cell systems. The energy conversion device is connected in series to each of the switching devices. The load is connected to each of the energy conversion devices. The control unit is configured to determine an operation of the plurality of the fuel cell systems. An electrical output of the plurality of the fuel cell systems is connected in parallel to the load through the switching devices and the energy conversion devices.

In some embodiments, the load may be a motor controller for an electric vehicle or an inverter for a stationary power application. In some embodiments, the switching device may be a contactor, a MOSFET, an IGBT, or a bipolar junction transistor. In some embodiments, the energy conversion device may be a DC-DC converter.

In some embodiments, a ranking system for each of the plurality of the fuel cell systems may be determined while each of the plurality of the fuel cell systems is not providing power, and the ranking system may be used to determine a preferred order of connection and disconnection of each of the plurality of the fuel cell systems based on a weighted averaging scheme of one or more factors. In some embodiments, the one or more factors may include availability of each of the plurality of the fuel cell systems, frequency of faults, alarms, or recoveries that the control unit has identified in each of the plurality of the fuel cell systems, or operating hours of each of the plurality of the fuel cell systems.

In some embodiments, predefined power levels may be identified for turning on and turning off each of the plurality of the fuel cell system based on a required power of the load. In some embodiments, the predefined power levels identified for turning on and turning off each of the plurality of the fuel cell systems may be dynamically adjusted based on historical operating data of each of the plurality of the fuel cell systems.

In some embodiments, the parallel configured system may have a minimum power setting and a maximum power setting, and the operation of each of the plurality of the fuel cell systems may be based on a range between the minimum power setting and the maximum power setting. In some embodiments, the parallel configured system may further comprise an end system integrator implemented to determine which of the plurality of the fuel cell systems should be turned on. In some embodiments, the end system integrator may model for any time delay incurred in turning on each of the plurality of the fuel cell systems.

According to a second aspect, described herein, a method for providing power to a load comprises implementing a plurality of fuel cell systems electrically connected in a parallel configuration, connecting each of the plurality of the fuel cell systems to a switching device in series, connecting each of the switching devices to an energy conversion device in series, connecting a load to each of the energy conversion devices, and implementing a control unit to determine operation of the plurality of the fuel cell systems. An electrical output of the plurality of the fuel cell systems is connected in parallel to the load through the switching devices and the energy conversion devices.

In some embodiments, the load may be a motor controller for an electric vehicle or an inverter for a stationary power application. In some embodiments, the switching device may be a contactor, a MOSFET, an IGBT, or a bipolar junction transistor. In some embodiments, the energy conversion device may be a DC-DC converter.

In some embodiments, the method may further comprise determining a ranking system for each of the plurality of the fuel cell systems while each of the plurality of the fuel cell systems is not providing power, and using the ranking system to determine a preferred order of connection and disconnection of each of the plurality of the fuel cell systems based on a weighted averaging scheme of one or more factors. In some embodiments, the one or more factors may include an availability of each of the plurality of the fuel cell systems, frequency of faults, alarms, or recoveries that the control unit has identified in each of the plurality of the fuel cell systems, or operating hours of each of the plurality of the fuel cell systems.

In some embodiments, the method may further comprise identifying predefined power levels for turning on and turning off each of the plurality of the fuel cell system based on a required power of the load. In some embodiments, the method may further comprise implementing an end system integrator to determine which of the plurality of the fuel cell systems should be turned on.

In some embodiments, the method may further comprise using the end system integrator to model for any time delay incurred in turning on each of the plurality of the fuel cell systems.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 is an illustration of N connected fuel cell systems, each with its own contactor and DC-DC converter, and which are connected in a parallel configuration;

FIG. 3 is an illustration of “turning on” power transition points (Pₒₙ) and “turning off” power transition points (P_{off}) implemented when operating each fuel cell system of FIG. 2; and

FIG. 4 illustrates an embodiment of a method implemented to determine the operation of the fuel cell systems of FIG. 2.

### DETAILED DESCRIPTION

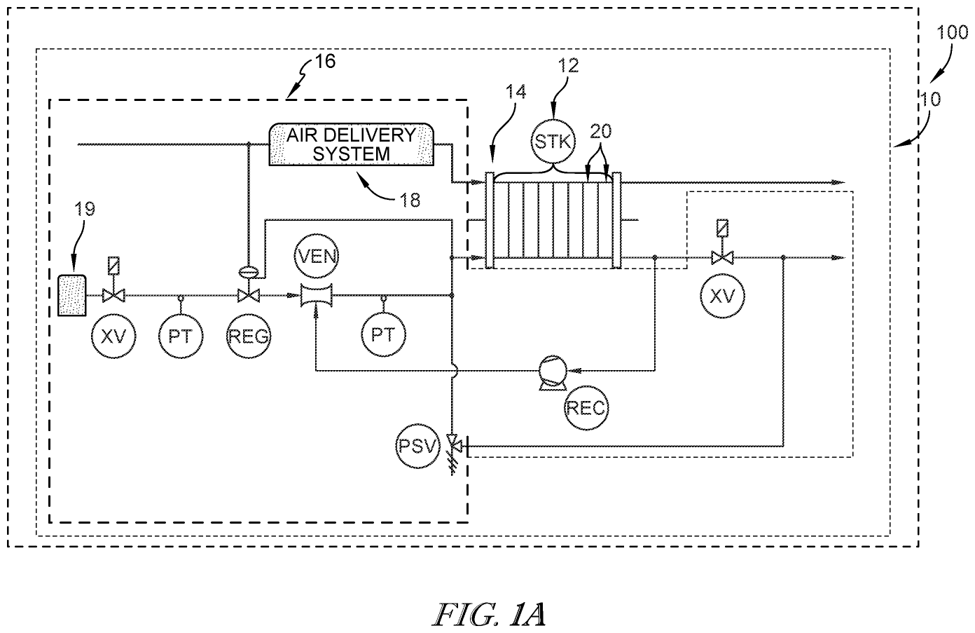

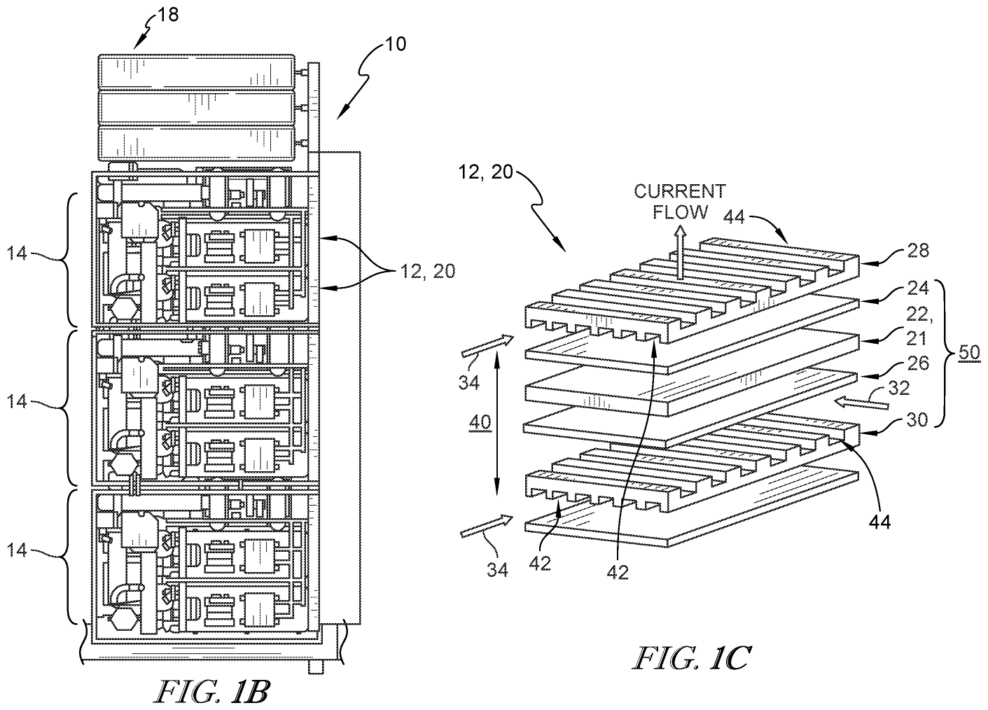

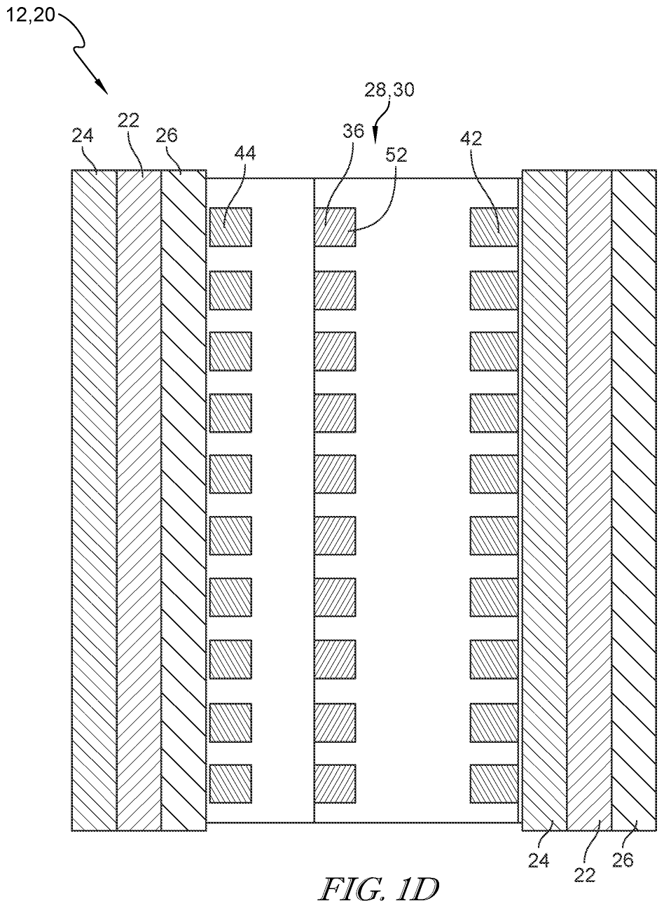

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system, or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

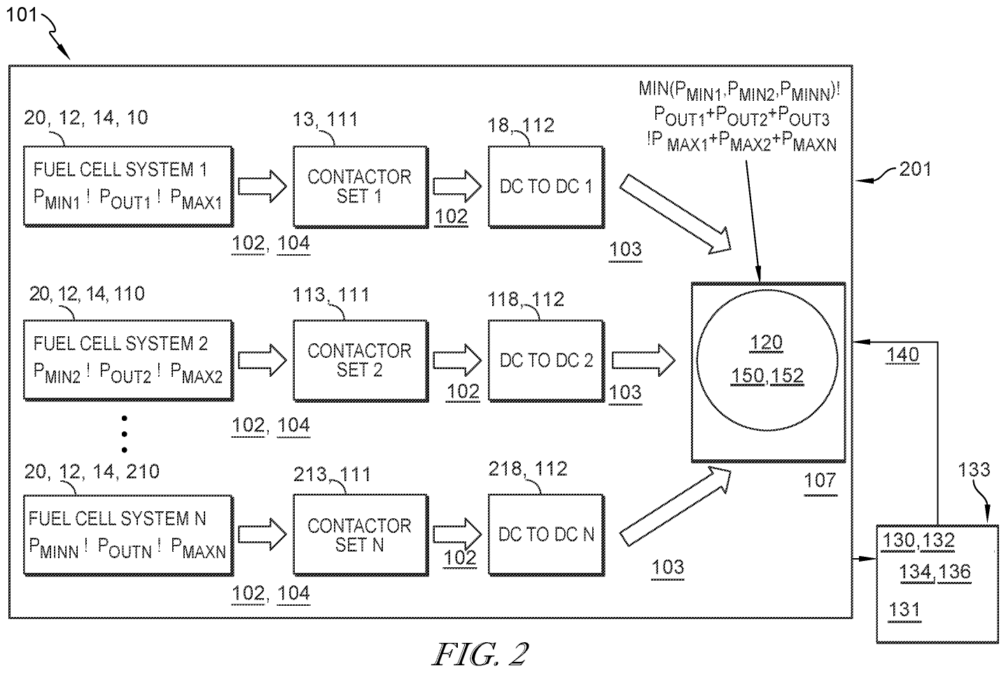

As shown in FIG. 1C, the fuel cell 20 produces electricity by electrochemically combining hydrogen 32 and oxygen 34 across a catalyst layer 21. As shown in FIG. 2, one or more fuel cell systems 10, 110, 210 comprising one or more fuel cells 20, or fuel cell stacks 12 are interconnected in a parallel configured system 101. A plurality of elements (e.g., fuel cells fuel cell modules 14, or fuel cell stacks 12) are connected in series to form each of the fuel cell systems 10, 110, 210. Fuel cells 20, fuel cell modules 14, or fuel cell stacks 12 are interconnected in a series configuration to increase the output voltage while fuel cells 20, fuel cell modules 14, or fuel cell stacks 12 are interconnected in a parallel configuration to increase the output current. In other embodiments, the plurality of fuel cells 20, fuel cell modules 14, or fuel cell stacks 12 may be connected in parallel to form the fuel cell systems 10, 110, 210.

By incorporating a switching device 111, such as a contactor 13, 113, 213, and an energy conversion device 112, such as a DC-DC converter 18, 118, 218, in a parallel configuration to a load 120, operation of each fuel cell 20 or fuel cell stack 12 in the fuel cell systems 10, 110, 210 can be controlled. Each switching device 111 is connected in series with each of the fuel cell systems 10, 110, 210. Each energy conversion device 112 is connected in series with the each switching device 111. The operation of each fuel cell 20 or fuel cell stack 12 is based on the load 120, which may vary with time and/or application.

The process of converting hydrogen 32 to electricity results in a direct current (DC). As shown in FIG. 2, the parallel configured system 101 includes fuel cell systems 10, 110, 210 that are utilized to produce direct current 102. The fuel cell systems 10, 110, 210 without any further power conditioning produce DC energy governed by a polarization curve. The fuel cell systems 110, 210 utilize the energy conversion device 112, such as the DC-DC converter 18, 118, 218, to convert the fuel cell 20 produced current 102 into a voltage 107 and a current 103 that can be supplied to the load 120. The load 120 operates by utilizing the current 103 from each of the DC-DC converters 18, 118, 218 to produce an alternating current (AC) voltage 107. Thus, the current 103 from each DC-DC converter 18, 118, 218 is combined to drive the load 120.

In some embodiments, as shown in FIG. 2, the same amount of current 103 is produced by each of the fuel cell systems 10, 110, 210. In other embodiments, the current 103 produced by each fuel cell system 10, 110, 210 may be different. In some embodiments, the current 103 may be converted to AC voltage 107 before reaching the load 120. Each fuel cell system 10, 110, 210 may have a range of allowable power outputs. The power output ranges of the fuel cell systems 10, 110, 210 may be established by the manufacturer of the system 10, 110, 210. The power output ranges of the fuel cell systems 10, 110, 210 may be similar or different from each other. The components of the fuel cell systems 10, 110, 210 are designed to optimize operational efficiency and performance of the parallel configured system 101.

Significant analysis of the load 120 is typically conducted prior to determining the exact configuration of the fuel cell system 10, 110, 210, or multiples thereof. The present disclosure provides systems and methods to determine initiation and/or operation of each fuel cell 20 or fuel cell stack 12 in the fuel cell systems 10, 110, 210 in the parallel configured system 101 depending on a load power (P_{load}) required by the load 120. More specifically, the present disclosure relates to determining if the operation of each component of the fuel cell system 10, 110, 210 varies with time and/or is dynamic. The decision of when to initiate the operation of each fuel cell 20 or fuel cell stack 12 in the fuel cell systems 10, 110, 210 in the parallel configured system 101 may be optimized based on fuel cell 20 or fuel cell stack 12 availability, efficiency, performance, and/or lifetime.

The sizing of the fuel cell system 10, 110, 210 may be based on power, voltage, and/or current considerations of the load 120. The load 120 may be a motor controller 150 for an electric vehicle 100 or an inverter 152 for a stationary powertrain 100. Alternatively, the load 120 may be any other application requiring electric power. In an illustrative embodiment, in FIG. 2, there is any number (N) of connected fuel cell systems 10, 110, 210.

The number or fuel cell systems 10, 110, 210 may range from about 1 to about 200, including any number or range comprised therein. For example, the any number (N) of connected fuel cell systems 10, 110, 210 may range from 1 to 5, from 5 to 10, from 10 to 20, from 20 to 50, from 50 to 100, or from 100 to 200, including any number or range comprised therein. In some embodiments, any number (N) of connected fuel cell systems 10, 110, 210 in the parallel configured system 101 may be more than 200.

The product of current and voltage determines the power available from the fuel cell system 10, 110, 210. Thus, the power available to operate the load 120 depends on the number (N) of fuel cell systems 10, 110, 210 being operated in the parallel configured system 101. Additionally, the parallel configured system 101 may be designed to ensure that the load 120 can continue to operate even if one or more of the fuel cell system(s) 10, 110, 210 has faulted and/or is not operational.

Each fuel cell system 10, 110, 210 is associated with its own switching device 111 and its own energy conversion device 112. The switching device 111 and the energy conversion device 112 are also connected in a parallel configuration. The switching device 111 may be a MOSFET, an IGBT, a bipolar junction transistor, or a dedicated contactor 13,113, 213. The energy conversion device 112 may be a DC-DC converter 18, 118, 218.

As shown in FIG. 2, the parallel configured system 101 is included in a fuel cell engine 201 and includes a controller 133. The contactor(s) 13, 113, 213 are coupled electrically to allow for bypass or connection to each fuel cell systems 10, 110, 210. A decision as to whether each fuel cell system 10, 110, 210 is bypassed, disconnected, and/or switched on is based on a sensory feedback loop 140. The sensory feedback loop 140 is an input into a finite state machine and fault management process 131 (e.g., an algorithm) that is embedded within the fuel cell controller 133. A decision as to whether each fuel cell system 10, 110, 210 is bypassed is based on the ability of the remaining fuel cell systems 10, 110, 210 within the parallel configured system 101 to provide continuous, uninterrupted flow of current to the load 120.

The allowable power output of any one of the fuel cell systems 10, 110, 210 ranging from 1 to N may be in the range of about Pₘᵢₙᵢ to about Pₘₐₓᵢ, where i ranges from 1 to N. Maximum power output from the fuel cell system 10, 110, 210 is Pₘₐₓᵢ. Minimum power output from the fuel cell system 10, 110, 210 is Pₘᵢₙᵢ. Maximum available power output of the parallel configured system 101 is the sum of the maximum power available from each of the fuel cell systems 10, 110, 210 (Pₘₐₓᵢs). Minimum power available of the parallel configured system 101 is the minimum of the minimum power available from each of the fuel cell systems 10, 110, 210 (Pₘᵢₙᵢs). Thus, the maximum and minimum available power of the parallel configured system 101 depends on the number of operational fuel cell systems 10, 110, 210.

The allowable operating range of the parallel configured system 101 is:

MIN(Pₘᵢₙ₁,Pₘᵢₙ₂,P_{minN})≤Pₒᵤₜ₁+Pₒᵤₜ₂+Pₒᵤₜ₃≤Pₘₐₓ₁+Pₘₐₓ₂+P_{maxN}

The DC-DC converter 18, 118, 218 combines the outputs (e.g., current 103) of each of the fuel cell systems 10, 110, 210 in the parallel configured system 101. The ability to combine the outputs (e.g., current 103) of each of the fuel cell systems 10, 110, 210 enables the parallel fuel cell system configuration 101 to produce more power compared to an implementation without DC-DC converters 18, 118, 218. Since the fuel cell systems 10, 110, 210 are configured in parallel, the output voltages 104 of the fuel cell systems 10, 110, 210 must align when delivering power in the absence of the DC-DC converters 18, 118, 218. Thus, it may not be possible to achieve the maximum power output of all N fuel cell systems 10, 110, 210 unless each system 10, 110, 210 has the same voltage in the absence of the DC-DC converter 18, 118, 218.

Additionally, in the event that one of the parallel connected fuel cell systems 10, 110, 210 in the parallel configured system 101 faults, the DC-DC 18, 118, 218 will be located in between the faulted fuel cell system 10, 110, 210 and the other operational fuel cell systems 10, 110, 210 such that the parallel configured system 101 can continue to deliver power to the load 120. A system control architecture 130 is embedded within a fuel cell main control unit 132 or as part of an external monitoring control system 134 or database master 136 in the parallel configured system 101 to ensure continuous power is provided to the load 120.

Additionally, the determination of when and which fuel cells systems 10, 110, 210 are enabled is optimized based on a time varying load requirement. Table 1 illustrates an embodiment of an analysis process that is implemented by the system control architecture 130. The system control architecture 130 is embedded within the fuel cell main control unit 132, as part of the external monitoring control system 134, or as the database master 136 capable of bidirectional communications with the parallel configured system 101.

The control unit 132 tracks several factors to determine the sequence of operating the one or more fuel cell systems 10, 110, 210. The factors may include, but are not limited to, a determination of any prevalent conditions of each fuel cell system 10, 110, 210 that potentially limit the ability of the fuel cell system 10, 110, 210 to provide power (e.g., availability of fuel cell system 10, 110, 210), frequency of faults, alarms, or recoveries that the control unit 132 has identified in the fuel cell system 10, 110, 210, and/or operating hours of each fuel cell system 10, 110, 210. The control unit 132 may implement an algorithm that weighs each of the factors and determine a selection order for operating the fuel cell systems 10, 110, 210 in the parallel configured system 101.

TABLE 1

| | Availability | | | |
|---|---|---|---|---|
| | of Series | | Oper- | |
| | Elements | Recov- | ating | |
| Fuel Cell | (e.g., fuel cell | ery | Hour | Combined |
| System | stacks 12) | State | Score | Ranking |
| 1 (e.g., fuel | A₁ | R₁ | H₁ | P₁ = W_{A} * A₁ + |
| cell system 10) | | | | W_{R} * R₁ + W_{H} * H₁ |
| 2 (e.g., fuel | A₂ | R₂ | H₂ | P₂ = W_{A} * A₂ + |
| cell system | | | | W_{R} * R₂ + W_{H} * H₂ |
| 110) | | | | |
| N (e.g., fuel | A_{N} | R_{N} | H_{N} | P_{N} = W_{A} * A_{N} + |
| cell system | | | | W_{R} * R_{N} + W_{H} * H_{N} |
| 210) | | | | |

W A is the weight applied to the availability of each element (e.g., fuel cell stack 12) in each fuel cell system 1 to N. W_{R} is the weight applied to recoveries or performance of each element (e.g., fuel cell stack 12) in each fuel cell system 1 to N. W_{H} is the weight applied to operating hours of each element (e.g., fuel cell stack 12) in each fuel cell system 1 to N.

Any change in the selection order for operating the fuel cell system 10, 110, 210 results in a contactor 13, 113, 213 switching event. To limit the number of contactor 13, 113, 213 switching events that occur while the fuel cell systems 10, 110, 210 are providing power, the determination of a selection order may only occur while the parallel configured system 101 is not providing power to the load 120. When the parallel configured system 101 starts providing power to the load 120, the fuel cell systems 10, 110, 210 that are on or online and the fuel cell systems 10, 110, 210 that are off or offline are identified based on the determined selection order.

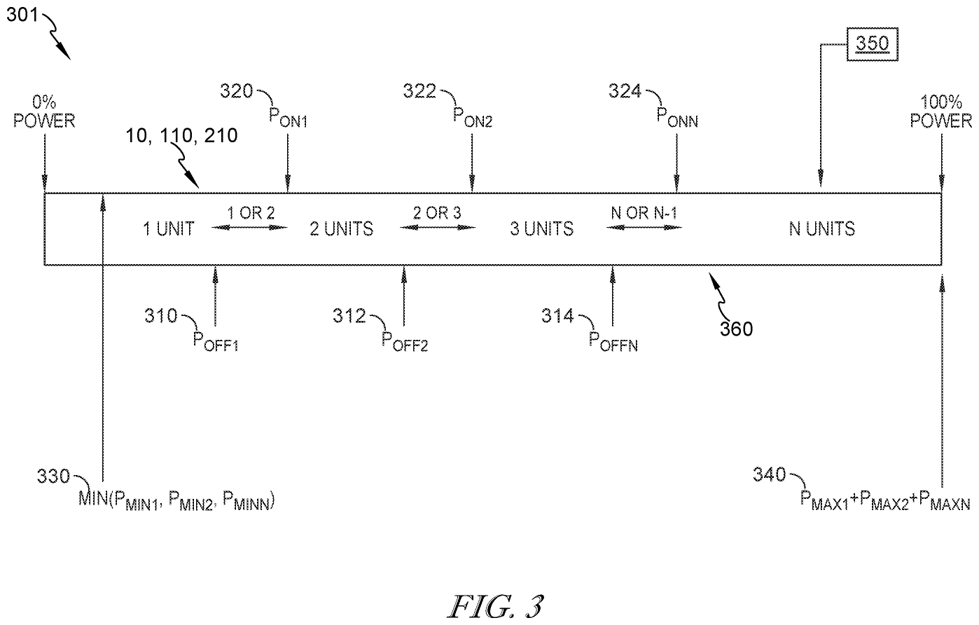

Power transition points may be defined or determined for each load 120. As shown in FIG. 3, the power transition points are transition points when the parallel configured system 101 transitions from operating one set of the fuel cell systems 10, 110, 210 to another set of the fuel cell systems 10, 110, 210 while providing power to the load 120. There may be one or more transition points associated with each load 120. In some embodiments, there may be N−1 power transition points (P_{ON(N-1)}) or “turning on” power transition points for bringing additional fuel cells systems 10, 110, 210 online, depending on the number (N) of fuel cell systems 10, 110, 210. Additionally, or alternatively, it may also be desirable to define different power transition points for bringing one or more fuel cell systems 10, 110, 210 offline. Thus, there may be an additional N−1 power transition points (P_{OFF(N-1)}) or “turning off” power transition points associated with turning off the fuel cell systems 10, 110, 210.

The “turning off” power transition points (P_{OFF(N-1)}) for each fuel cell systems 10, 110, 210 may be a lower power level than the counterpart “turning on” power transition points (P_{ON(N-1)}) such that there is hysteresis embedded in the enabling and disabling of each fuel cell system 10, 110, 210. There may not be any induced nuisance switching that occurs during the transitions from turning on to turning off and vice versa. Table 2 illustrates an embodiment for determining or defining the “turning on” power transition points to bring one or more fuel cell system 1-N (e.g., fuel cell systems 10, 110, 210) online.

TABLE 2

| | Number of Fuel Cell |
|---|---|
| Load Power | Systems Enabled |
| <MIN (Pₘᵢₙ₁, Pₘᵢₙ₂, P_{minN}) | 0 |
| ≥MIN ((Pₘᵢₙ₁, Pₘᵢₙ₂, P_{minN}) | 1 |
| <P_{ON1} | |
| ≥P_{ON1} | 2 |
| <P_{ON2} | |
| ≥P_{ON2} | 3 |
| <P_{ON(N-1)} | |
| ≥P_{ON(N-1)} | N |

P_{ON1} is the defined power transition point when the parallel configured system 101 transitions from operating one (1) to two (2) fuel cell systems. P_{OFF1} is the defined power transition point when the parallel configured system 101 transitions from operating two (2) to one (1) fuel cell system. P_{ON2} is the defined power transition point when the parallel configured system 101 transitions from operating two (2) to three (3) fuel cell systems. P_{OFF2} is the defined power transition point when the parallel configured system 101 transitions from operating three (3) to two (2) fuel cell systems. P_{ON(N-1)} is the defined power transition point when the parallel configured system 101 transitions from operating N−1 fuel cell systems to N fuel cell systems. P_{OFF(N-1)} is the defined power transition point when the parallel configured system 101 transitions from operating N fuel cell systems to N−1 fuel cell systems.

FIG. 3 illustrates a method 301 for operating the different fuel cell systems 10, 110, 210 in the parallel configured system 101. As shown in FIG. 3, the determination of the “turning on” power transition points (Pₒₙ) 320, 322, 324 and the “turning off” power transition points (P_{off}) 310, 312, 314 may be tuned for each load 120. When the “turning on” power transition point (Pₒₙ) 320, 322, 324 or the “turning off” power transition point (P_{off}) 310, 312, 314 is zero, their impact on switching behavior of the fuel cell system 10, 110, 210 is eliminated. Consequently, the fuel cell systems 10, 110, 210 only adhere to operational limits determined by a minimum power setting Pₘᵢₙ 330 and a maximum power setting Pₘₐₓ 340 settings for the parallel configured system 101.

By increasing a range 360 between the minimum power setting Pₘᵢₙ 330 and maximum power setting Pₘₐₓ 340 settings, an end system integrator 350 can be implemented to determine which fuel cell systems 10, 110, 210 to turn on. Additionally, for exceptionally dynamic load 120, the integrator 350 may also model for any time delay in turning on each fuel cell system 10, 110, 210.

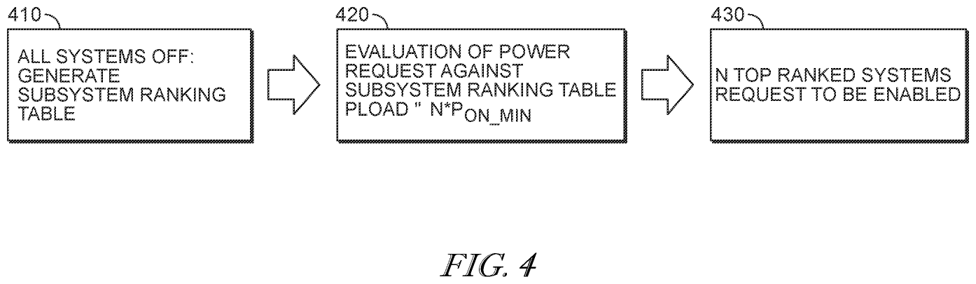

FIG. 4 illustrates an embodiment of a method implemented to determine the operation of the fuel cell systems 10, 110, 210 in the parallel configured system 101 shown in FIG. 2. The method includes determining if all the fuel cell systems 10, 110, 210 are turned off in step 410. When all the fuel cell systems 10, 110, 210 are determined to be turned off, power request by the load 120 is evaluated based on a ranking table in step 420. Based on the evaluation of the power request by the load 120, a top ranked fuel cell system 10, 110, 210 is identified and enabled in step 430. The ranking table may be based on predefined load 120 and/or power levels (e.g., “turning on” and “turning off” power transition points shown in FIG. 3). Such predefined load 120 and/or power levels may be used by the controller 133 to initiate the operation of one or more of the fuel cell systems 10, 110, 210. The predefined load 120 and/or power levels may be identified based on database, maps, predictive algorithms, etc. The predefined load 120 and/or power levels may be dynamically adjusted based on historical operating data of the fuel cell systems 10, 110, 210. Historical operating may include, but is not limited to operating limits associated with each of the fuel cell stacks 12 or fuel cells 20 in the fuel cell systems 10, 110, 210, frequency of faults, alarms, or recoveries of the fuel cell systems 10, 110, 210, and/or maximum and minimum power associated with the fuel cell systems 10, 110, 210.

The following described aspects of the present invention are contemplated and non-limiting:

A first aspect of the present invention relates to a parallel configured system. The parallel configured system comprises a plurality of fuel cell systems, a switching device, an energy conversion device, a load, and a system controller. The plurality of fuel cell systems are electrically connected in a parallel configuration. The switching device is connected in series to each of the plurality of the fuel cell systems. The energy conversion device is connected in series to each of the switching devices. The load is connected to each of the energy conversion devices. The system controller is configured to determine an operation of the plurality of the fuel cell systems. An electrical output of the plurality of the fuel cell systems is connected in parallel to the load through the switching devices and the energy conversion devices.

A second aspect of the present invention relates to a method for providing power to a load comprises. The method for providing power to a load comprises implementing a plurality of fuel cell systems electrically connected in a parallel configuration, connecting each of the plurality of the fuel cell systems to a switching device in series, connecting each of the switching devices to an energy conversion device in series, connecting a load to each of the energy conversion devices, and implementing a system controller to determine operation of the plurality of the fuel cell systems. An electrical output of the plurality of the fuel cell systems is connected in parallel to the load through the switching devices and the energy conversion devices.

In the first aspect of the present invention, the load may be a motor controller for an electric vehicle or an inverter for a stationary power application. In the first aspect of the present invention, the switching device may be a contactor, a MOSFET, an IGBT, or a bipolar junction transistor. In the first aspect of the present invention, the energy conversion device may be a DC-DC converter.

In the first aspect of the present invention, a ranking system for each of the plurality of the fuel cell systems may be determined while each of the plurality of the fuel cell systems is not providing power, and the ranking system may be used to determine a preferred order of connection and disconnection of each of the plurality of the fuel cell systems based on a weighted averaging scheme of one or more factors. In the first aspect of the present invention, the one or more factors may include availability of each of the plurality of the fuel cell systems, frequency of faults, alarms, or recoveries that the control unit has identified in each of the plurality of the fuel cell systems, or operating hours of each of the plurality of the fuel cell systems.

In the first aspect of the present invention, predefined power levels may be identified for turning on and turning off each of the plurality of the fuel cell system based on a required power of the load. In the first aspect of the present invention, the predefined power levels identified for turning on and turning off each of the plurality of the fuel cell systems may be dynamically adjusted based on historical operating data of each of the plurality of the fuel cell systems.

In the first aspect of the present invention, the parallel configured system may have a minimum power setting and a maximum power setting, and the operation of each of the plurality of the fuel cell systems may be based on a range between the minimum power setting and the maximum power setting. In the first aspect of the present invention, the parallel configured system may further comprise an end system integrator implemented to determine which of the plurality of the fuel cell systems should be turned on. In the first aspect of the present invention, the end system integrator may model for any time delay incurred in turning on each of the plurality of the fuel cell systems.

In the second aspect of the present invention, the load may be a motor controller for an electric vehicle or an inverter for a stationary power application. In the second aspect of the present invention, the switching device may be a contactor, a MOSFET, an IGBT, or a bipolar junction transistor. In the second aspect of the present invention, the energy conversion device may be a DC-DC converter.

In the second aspect of the present invention, the method may further comprise determining a ranking system for each of the plurality of the fuel cell systems while each of the plurality of the fuel cell systems is not providing power, and using the ranking system to determine a preferred order of connection and disconnection of each of the plurality of the fuel cell systems based on a weighted averaging scheme of one or more factors. In the second aspect of the present invention, the one or more factors may include an availability of each of the plurality of the fuel cell systems, frequency of faults, alarms, or recoveries that the control unit has identified in each of the plurality of the fuel cell systems, or operating hours of each of the plurality of the fuel cell systems.

In the second aspect of the present invention, the method may further comprise identifying predefined power levels for turning on and turning off each of the plurality of the fuel cell system based on a required power of the load. In the second aspect of the present invention, the method may further comprise implementing an end system integrator to determine which of the plurality of the fuel cell systems should be turned on.

In the second aspect of the present invention, the method may further comprise using the end system integrator to model for any time delay incurred in turning on each of the plurality of the fuel cell systems.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A parallel configured system comprising:
a plurality of fuel cell systems electrically connected in a parallel configuration,
a switching device connected in series to each of the plurality of the fuel cell systems,
an energy conversion device connected in series to each of the switching devices,
a load connected to each of the energy conversion devices, and
a control unit configured to determine an operation of the plurality of the fuel cell systems,
wherein an electrical output of the plurality of the fuel cell systems is connected in parallel to the load through the switching devices and the energy conversion devices.

2. The parallel configured system of claim 1, wherein the load is a motor controller for an electric vehicle or an inverter for a stationary power application.

3. The parallel configured system of claim 1, wherein the switching device is a contactor, a MOSFET, an IGBT, or a bipolar junction transistor.

4. The parallel configured system of claim 1, wherein the energy conversion device is a DC-DC converter.

5. The parallel configured system of claim 1, wherein a ranking system for each of the plurality of the fuel cell systems is determined while each of the plurality of the fuel cell systems is not providing power, and the ranking system is used to determine a preferred order of connection and disconnection of each of the plurality of the fuel cell systems based on a weighted averaging scheme of one or more factors.

6. The parallel configured system of claim 5, wherein the one or more factors include availability of each of the plurality of the fuel cell systems, frequency of faults, alarms, or recoveries that the control unit has identified in each of the plurality of the fuel cell systems, or operating hours of each of the plurality of the fuel cell systems.

7. The parallel configured system of claim 1, wherein predefined power levels are identified for turning on and turning off each of the plurality of the fuel cell system based on a required power of the load.

8. The parallel configured system of claim 7, wherein the predefined power levels identified for turning on and turning off each of the plurality of the fuel cell systems are dynamically adjusted based on historical operating data of each of the plurality of the fuel cell systems.

9. The parallel configured system of claim 1, wherein the parallel configured system has a minimum power setting and a maximum power setting, and the operation of each of the plurality of the fuel cell systems is based on a range between the minimum power setting and the maximum power setting.

10. The parallel configured system of claim 1, wherein the parallel configured system further comprises an end system integrator implemented to determine which of the plurality of the fuel cell systems should be turned on.

11. The parallel configured system of claim 10, wherein the end system integrator models for any time delay incurred in turning on each of the plurality of the fuel cell systems.

12. A method for providing power to a load comprising:
implementing a plurality of fuel cell systems electrically connected in a parallel configuration,
connecting each of the plurality of the fuel cell systems to a switching device in series,
connecting each of the switching devices to an energy conversion device in series,
connecting a load to each of the energy conversion devices, and
implementing a control unit to determine operation of the plurality of the fuel cell systems,
wherein an electrical output of the plurality of the fuel cell systems is connected in parallel to the load through the switching devices and the energy conversion devices.

13. The method of claim 12, wherein the load is a motor controller for an electric vehicle or an inverter for a stationary power application.

14. The method of claim 12, wherein the switching device is a contactor, a MOSFET, an IGBT, or a bipolar junction transistor.

15. The method of claim 12, wherein the energy conversion device is a DC-DC converter.

16. The method of claim 12, further comprising determining a ranking system for each of the plurality of the fuel cell systems while each of the plurality of the fuel cell systems is not providing power, and using the ranking system to determine a preferred order of connection and disconnection of each of the plurality of the fuel cell systems based on a weighted averaging scheme of one or more factors.

17. The method of claim 16, wherein the one or more factors include an availability of each of the plurality of the fuel cell systems, frequency of faults, alarms, or recoveries that the control unit has identified in each of the plurality of the fuel cell systems, or operating hours of each of the plurality of the fuel cell systems.

18. The method of claim 12, further comprising identifying predefined power levels for turning on and turning off each of the plurality of the fuel cell system based on a required power of the load.

19. The method of claim 12, further comprising implementing an end system integrator to determine which of the plurality of the fuel cell systems should be turned on.

20. The method of claim 19, further comprising using the end system integrator to model for any time delay incurred in turning on each of the plurality of the fuel cell systems.
